(19) United States
(12) Patent Application Publication
(10) Pub. No.: US 2010/0131386 A1
(43) Pub. Date: May 27, 2010

(54) E-Commerce Purchase Eligibility Determination System and Method

(75) Inventors: Brent D. Shiely, Eden Prairie, MN (US); Michael E. Conner, Aliso Viejo, CA (US); David A. Woolenberg, Woodinville, WA (US); Matthew John Voda, Minneapolis, MN (US); Jeffrey M. Diesner, Costa Mesa, CA (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 12/626,542

(22) Filed: Nov. 25, 2009

Related U.S. Application Data
(60) Provisional application No. 61/235,318, filed on Aug. 19, 2009.
(60) Provisional application No. 61/117,704, filed on Nov. 25, 2008.

(51) Int. Cl. G06Q 30/00; G06Q 99/00; G06Q 10/00

(52) U.S. Cl. 705/26; 705/310; 705/318

(57) ABSTRACT

A system and method for determining e-commerce purchase eligibility of product offerings restricted to particular market segments and used in conjunction with an e-commerce system is described. Identifying information provided by the user is compared to a white list of eligibility parameters selected and configured by the vendor. An e-mail confirming eligibility and containing a customized URL is provided to the user; selecting the link automatically logs the user into the account. The system allows limited or unlimited purchases to be made by qualified users. Fraud detection is performed prior to checkout. Once the order has been processed the user may immediately download the product. An e-mail is sent to the user providing delayed downloading instructions and license key. Downloading may inject the license key for automatic software product or application activation.

This application claims the benefit of the following:
U.S. Provisional Application No. 61/117,704 filed Nov. 25, 2008 entitled “E-Commerce Purchase Eligibility Determination System and Method;” and
U.S. Provisional Application No. 61/235,318 filed Aug. 19, 2009 entitled “E-Commerce Bulk License Purchase with End User Eligibility Determination System and Method,” both of which are incorporated herein by reference.

### FIELD OF THE INVENTION

The present invention relates to determination of eligibility requirements for the online purchase of limited quantity product offers. More particularly, the present invention relates to a system and related tools for determining whether a prospective buyer meets the qualifications to purchase a product under a particular offer.

### BACKGROUND OF THE INVENTION

The growth and development of the internet has provided an inexpensive and fast way to sell and distribute digital products, such as software. Digital products may require a significant investment to produce the first copy, but they are easy to reproduce, have a low marginal production cost and low distribution costs. This is true for products that are transferred to a variety of media, including CDs and DVDs, but the Internet provides an even greater benefit by allowing customers to purchase and download digital products on demand.

Software vendors with innovative products are often concerned about getting their product out to those customers who are most likely to use, recommend, and purchase products or upgraded versions. With the extensive demographic data available today, software vendors can not only target sales to a preferred market, but may also use price discrimination to reach out and hook those heavy users, such as students, who currently have few resources, but may become loyal purchasers as time passes.

An opportunity exists for software vendors to increase their market penetration and hook customers who may be more likely to purchase upgrades and related products in the future. In order to introduce customers to a product and encourage a lifetime relationship, a software vendor may segment its customers and choose to offer one prospectively profitable segment an item or bundle of items at a particularly good price. An online vendor will often offer a product for sale or distribution of information in limited quantities and/or to a restricted group of qualified users. This strategy usually offers benefits for both parties; the purchaser may receive the software at a low or discounted price, and the vendor gets his product into the hands of a customer who may be more likely to purchase upgrades and additional products in the future.

In order to ensure that only qualified members of the specific segment are able to purchase the items for sale, and/or are only allowed to purchase limited quantities of the items, a system should be able to recognize an indicator of qualification and apply business rules to the sale. One example of such an offer would be an academic licensing program, which offers steep discounts to users on confirmation of their enrollment in a qualified school or program. Academic software has traditionally been sold through on-campus bookstores and value added resellers. With the advent of e-commerce the purchase of software has evolved to where the software may be immediately downloaded upon purchase with a backup copy of the software shipped to the purchaser making it easy for a user to get immediate gratification.

Another example might be a bulk license program. A business customer may to purchase a large number of software licenses for its employees, for business or personal use. Such an option might allow the business customer to take advantage of bulk discounts and provide a benefit to its employees, and at the same time allow the seller to recognize a significant sale before all licenses have been distributed.

An e-commerce system operatively configured to provide online providers with the ability to offer digital or other products to specific market segments necessarily includes two or more computers, computational devices or servers and a network connection allowing a user at one computer to access applications or programs located on another computer or server. It would be understood by one of ordinary skill in the art that the term “computer” as used herein, may refer to any of such device which contains a processor and some type of memory. The networks connecting such devices may be “wired” networks, formed using lines such as copper wire or fiber optic cable, wireless networks employing earth and/or satellite-based wireless transmission links, or combinations of wired and wireless network portions. Many such networks may be organized using a client/server architecture, in which “server” computational devices manage resources, such as files, peripheral devices, or processing power, which may be requested by “client” computational devices. “Proxy servers” can act on behalf of other machines, such as either clients or servers. Servers are not, however, local computers, which are typically those used by end users to request information from a server. Any number of computers, computational devices or servers may be connected to a network.

A need exists for making e-commerce purchase eligibility determination more streamlined, flexible, and accessible to clients. The present invention provides a solution to these needs and other problems, and offers other advantages over the prior art.

### BRIEF SUMMARY OF THE INVENTION

The present invention is related to a computer-implemented system that solves the above-mentioned problems. In accordance with one embodiment of the invention, a computer software marketing system allowing limited purchases to be made by qualified, targeted users is described. A preferred embodiment of such a system might include any type of provider web site(s) with items to sell or distribute, connected to a user via a pre-existing network such as the Internet. The provider may host its own web store or may obtain services from an e-commerce service provider, operatively connected with it over the pre-existing network.

In a preferred embodiment, the user navigates to the site and registers using a qualification parameter. The system validates the parameter as being eligible, creates an account and sends an e-mail to the user with a custom linking universal resource locator (URL) containing login credentials created specifically for the user. Forwarding the e-mail may automatically make the associated e-mail address ineligible for the program. When the user activates the link, the user is redirected to a web store and automatically logged into the account. The user may choose from a group of selected products for purchase. The quantity or available products may be limited by business rules. Prior to the final checkout, the user's information may be verified with a database to determine if business rules are being violated, and processed by a fraud detection and analysis module. If all business rules are met and fraud detection is passed, the user checks out and a record is written to a verification database for future validation.

In another embodiment, a web store may be configured to provide a bulk ordering interface for corporate customers, a storefront for individuals to purchase individual licenses and download the software, digital fulfillment and a “security lock box” holding the keys purchased by the corporate customer to be distributed when individual end users purchase an individual license.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is diagram of an exemplary preferred embodiment of an e-commerce purchase eligibility determination system in context.

FIGS. 2a and 2b show preferred embodiment password, qualifying identifier maintenance, authentication setting, and un-verified action screens of an e-commerce purchase eligibility determination system maintenance graphical user interface (GUI).

FIGS. 3a, 3b and 3c describe a preferred embodiment process flow that occurs when an end user/customer makes a purchase.

FIG. 4 illustrates a preferred embodiment process flow for a bulk pre-purchase of software keys.

FIG. 5 is an example of a data model for user validation.

FIG. 6 describes preferred embodiment methods and attributes of a user validation class.

FIG. 7 describes preferred embodiment methods and attributes of an exemplary registration form.

FIG. 8 illustrates a preferred embodiment initial site user validation process.

FIG. 9 is an example of a data model for requisition history.

FIG. 10 is a sequence diagram illustrating preferred embodiment methods for validating a purchase transaction.

FIG. 11 is a data model showing an exemplary group of methods used to implement an e-commerce purchase eligibility system and method.

### DETAILED DESCRIPTION

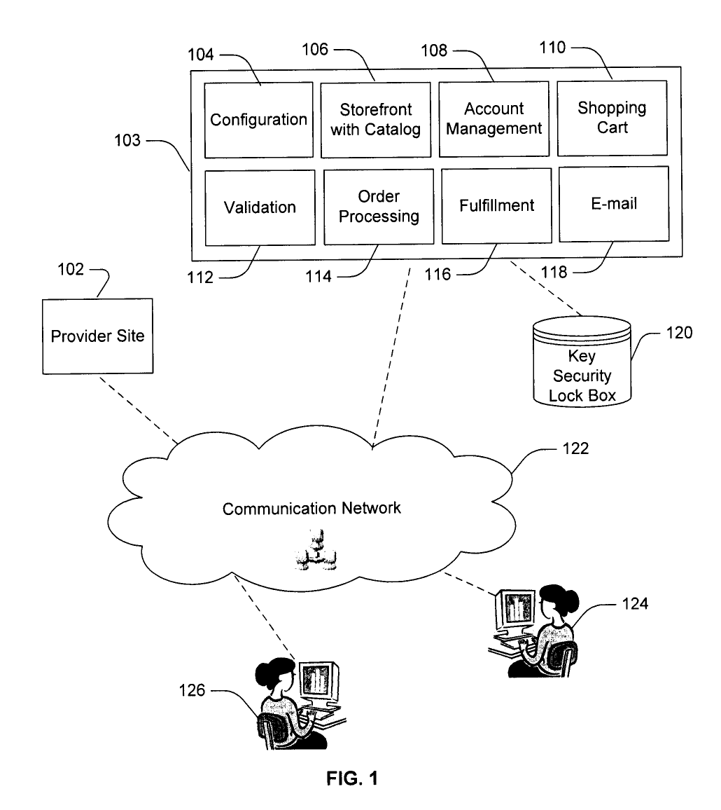

An exemplary e-commerce system is illustrated in FIG. 1. The system might include any type of provider web site(s) 102 with items to sell or distribute, possibly hosted on a web server, and connected with an e-commerce system 103 via a pre-existing network 122 such as the Internet. The exemplary data processing system includes various computers or computing devices, including end user machines 124, 126, web site servers 102, and an e-commerce system or platform 103 hosted on one or more servers. Each computer or computing device has a connection with a network 122 such as the Internet or other type of data network. The computer or computing device typically includes a memory, a secondary storage device, a processor, an input device, a display device, and an output device. The memory may include random access memory (RAM) or similar types of memory.

Software applications, stored in the memory or secondary storage for execution by a processor are operatively configured to perform the operations of the exemplary system. The software applications may correspond with a single module or any number of modules which are instructions for controlling a computer to perform a particular method. The modules preferably implement the features or operations of the system. The modules may also be implemented using program products or a combination of software and specialized hardware components. In addition, the modules may be executed on multiple processors for processing a large number of transactions, if necessary or desired.

The secondary storage device may include a hard disk drive, floppy disk drive, CD-ROM drive, DVD-ROM drive, or other types of non-volatile data storage, and it may correspond with the various databases shown in the figures. The processor may execute the software applications or programs either stored in memory or secondary storage or received from the Internet or other network. The input device may include any device for entering information into computer, such as a keyboard, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer or computing device has been described with various components, one skilled in the art will appreciate that this computer can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM.

The e-commerce system, or platform, provides various purchase eligibility and fulfillment functionality through modules which may include: a configuration module 104 or console, such as a graphical user interface (GUI) or data management tools (i.e. data loader, etc) to configure and maintain qualification and restriction requirements; a catalog or presentation module 106 to display items available for sale or distribution to users; an account management module 108 to create user accounts; a shopping cart module 110 to collect the user's selected items; a validation module 112 containing the logic for determining eligibility; an order processing module 114 to complete the sale and perform billing and payment operations; a fulfillment module 116 to maintain product locations or products for download or interface with warehouse systems for physical fulfillment; and an e-mail module 118 to forward account and distribution instructions and links to users. The description of such modules is intended to be illustrative and in no way limiting. One skilled in the art would appreciate that other modules and functions may be provided, depending on business requirements. The system may also provide a key security lock box 120, which generates the keys required for licensing the purchased software. The system may be accessed by users 124, 126 via that same network.

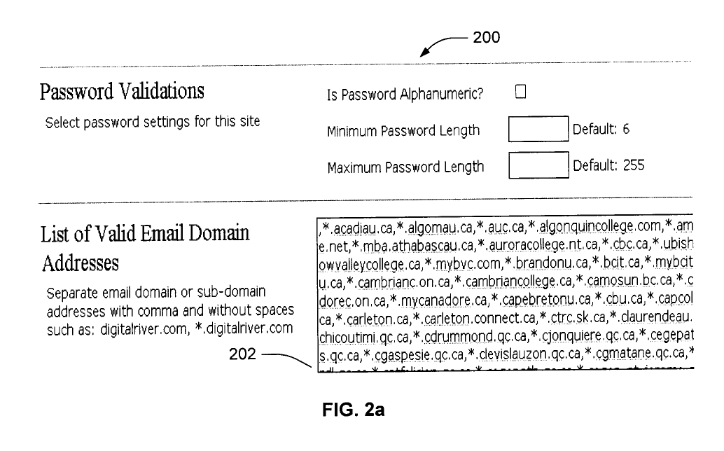

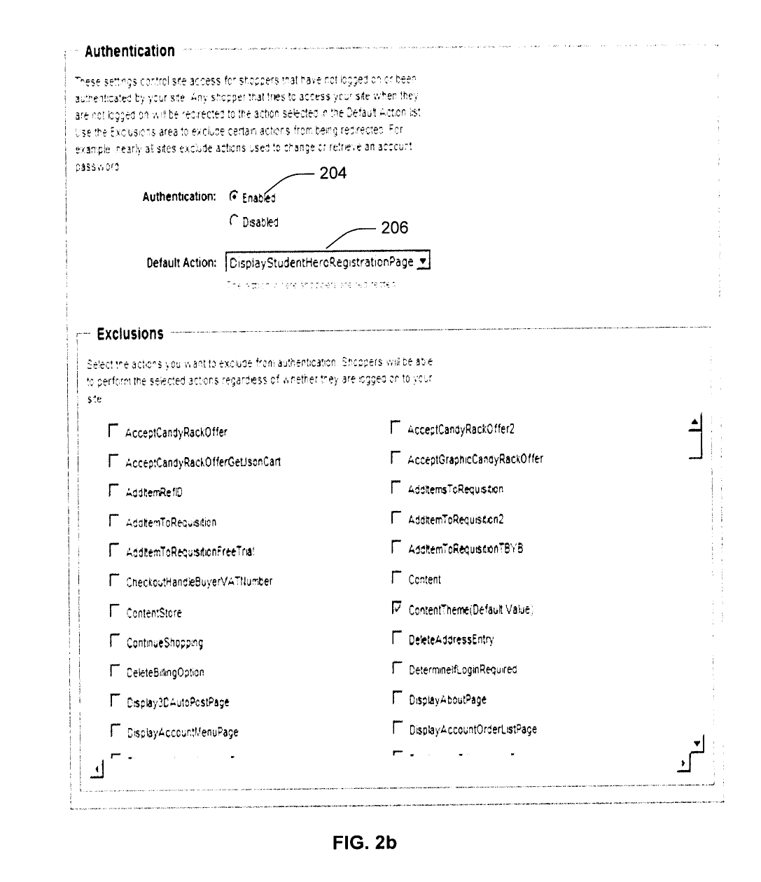

The system and method provides eligibility determination for providers who want to limit purchase or distribution parameters such as quantity and type of customer. Qualifying users may be defined and identified to meet the provider's business requirements. For example, the system may verify user qualification using a number of white-listed identifiers: an explicit list of e-mail addresses, one or more top-level domain identifiers (i.e., .gov, .org, .edu, etc.), one or more domain name identifiers (i.e., uspto.gov, adlf.org, umn.edu) or one or more codes, such as promotion codes, user id or organization id (i.e. government employee id#, AARP#, etc.). FIGS. 2a and 2b provide exemplary screens 200, that may be used to configure an e-commerce purchase eligibility system and method. A provider may set requirements for password validation and for valid domain addresses 202.

Referring to FIG. 2b, a graphical user interface (GUI) may be provided to the software vendor's account manager, allowing her to choose the criteria and products for an offer. A list may be created, viewed and maintained through the GUI. The list could also be uploaded to the system using a spreadsheet or other list format and a data load program or tool. The account manager uses these tools to update current “white-listed,” or allowed, domains, sub-domains or e-mails for e-mail verification. The account manager sets the authentication requirements by assigning a default action that controls access for shoppers that have not been authenticated 302. The manager also chooses those actions to which the shopper will be allowed to access without having been authenticated (“exclusions”) 304. These are actions that the shopper will be allowed to visit without having been authenticated.

### Single Purchase Process

The following paragraphs describe the process for determining eligibility in the context of an online software purchase. The use of this invention for software sales is an example only, and one skilled in the art would appreciate that any product or document that could be delivered physically (backup CDs or DVDs) or electronically may be sold or distributed, including books, video, music, coupons, etc.

In this example, a software vendor creates a campaign to offer bundled products to students, located in several countries, at a very low price. The vendor creates a web interface on its site 102 and associates it with a web storefront and purchase eligibility system on an e-commerce system 103. The vendor uploads into the purchase eligibility system a white list of eligible e-mail domain and sub-domain addresses 202 for educational domains, and configures the site flow in the configuration module 104, 200. The product is added to the catalog and is configured for sale. Product keys are prepared and stored in a database 120 for distribution and future verification.

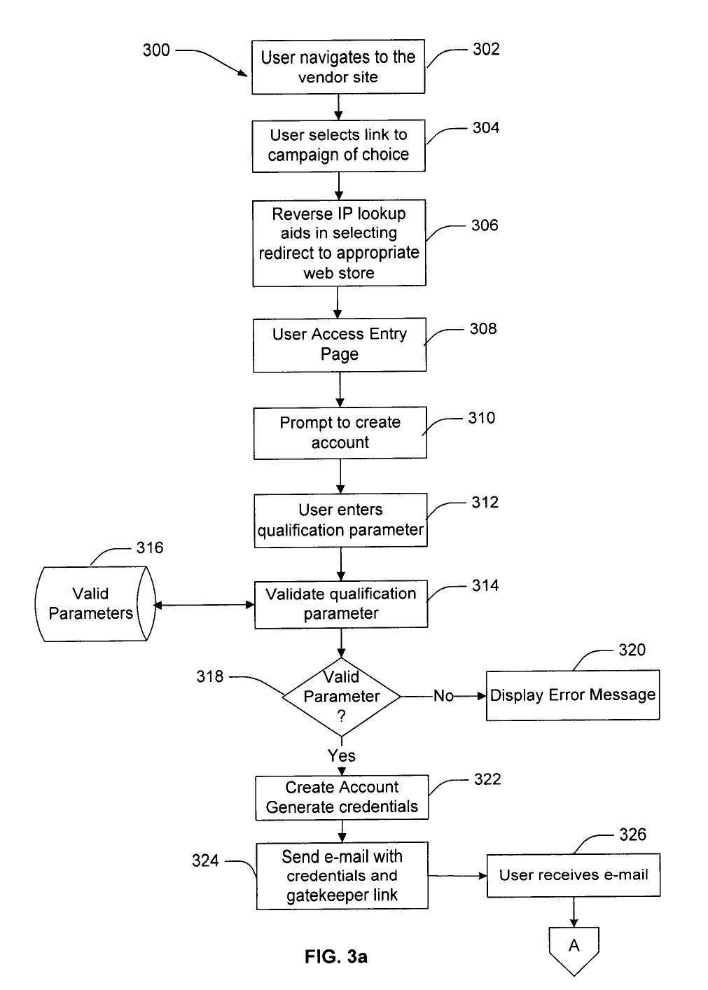

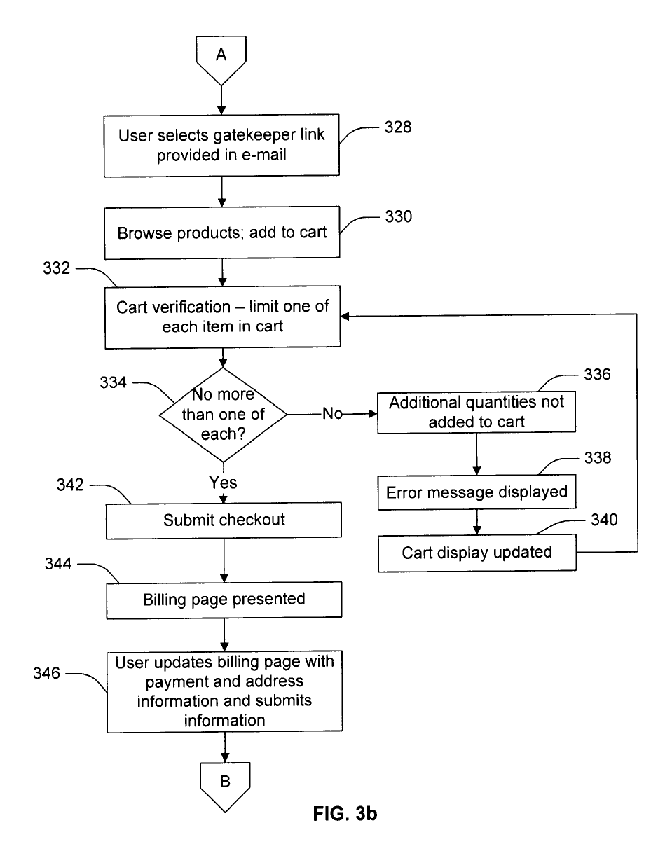

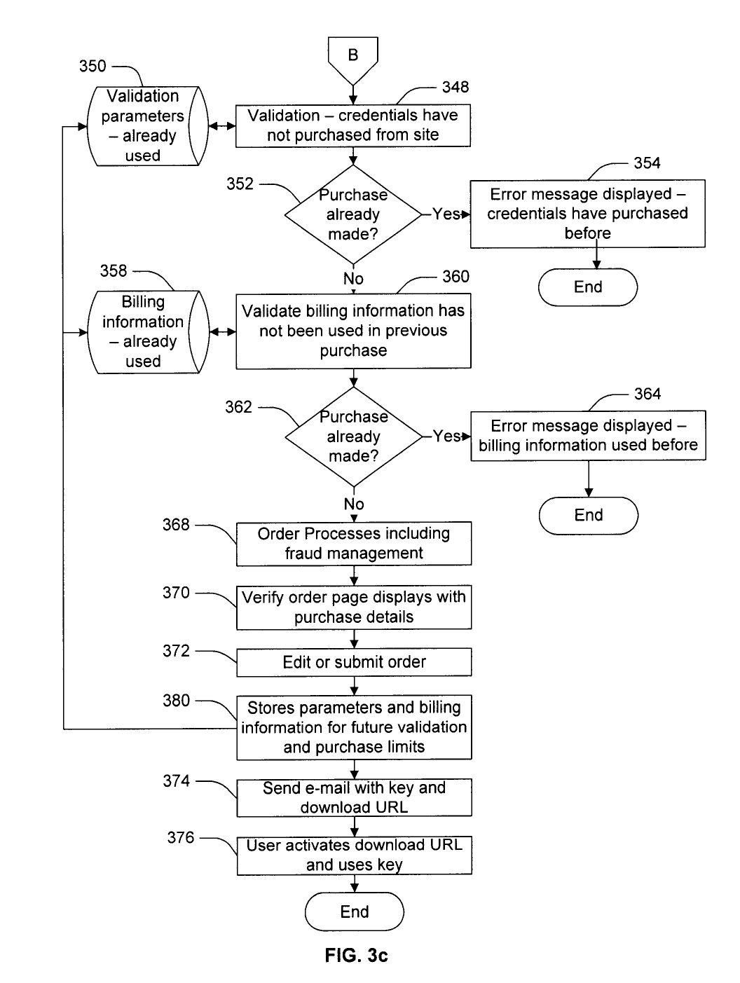

Referring to FIGS. 3a-3c, users navigate to the vendor site 302, select a link to the campaign 304, and are redirected to the web store. Using a reverse IP lookup or some other indicator of the request's country of origin 306, the user is directed to the appropriate web site and access entry page 308 for the language and currency of the request's geographic origin. For instance, a user located in the US would be directed to a US site using the English language and presenting the offer price in US currency. If the user wishes to make a purchase, s/he is prompted 310 to register or create an account using their e-mail address 312. The user enters their validation parameter (such as e-mail address with .edu domain extension) 312. The system checks the qualification parameter 314 against those configured in 202 and stored in the database 316. If the system determines that the user's e-mail address is not qualified (not on the list of valid e-mail domain addresses), the user is not eligible and an error page is displayed 320. If the system verifies the identifier as eligible, account credentials are generated 322 and an eligibility confirmation page is displayed and an eligibility confirmation e-mail 324 is sent to the provided e-mail address of the qualified student, or requestor. The e-mail contains a link to a store gatekeeper page. The link may be unique to the account associated with the student, and may include the userID and password for the account. The link is valid for a pre-determined amount of time configured by the vendor (e.g. 30 days). When the student retrieves the e-mail 326 and clicks the link 328 s/he is directed to the e-commerce system and automatically logged in to the system. The product description page is displayed and the student may add products to the shopping cart 330. As products are added, the shopping cart page is displayed. Other related products may be added, such as a hard copy of the software when a downloaded product is selected, with an option to remove them from the list. The cart verifies 334 per item limits as configured by the provider 332. For instance, an offer for one copy of an item (i.e., a business rule limit on quantity of product purchases) will prevent additional copies from being added to the cart 336. An error message is displayed 338 and the cart is updated to remove the duplicate products 340. When the shopping cart holds the products the student wishes to purchase, the student selects ‘checkout’ 342 and a billing page 344 appears with e-mail field prepopulated based on the unique URL; typical billing fields appear with “soft verification” that consists of a scroll box of program terms and text box that must be “checked” to confirm the student falls within program terms. Next, the user inputs data into the billing page 346. such as payment and address information, and submits the data.

When ‘submit’ is selected, the student may be verified by one or more of the following controls: an e-mail purchase restriction 348, a product purchase limitation, 352, a credit card purchase limitation (i.e. one purchase per billing location) 360, followed by fraud detection 368 and payment verification 368. If the purchase passes all controls, the Verify order page appears 370, detailing the order. The student may edit or submit the order 372. Editing the page may trigger changes to the shopping cart and billing page; submit may trigger updates to the purchase confirmation page (order details, product key, downloads); and the purchase confirmation e-mail (order details, product key). A record is created in the appropriate limitation database (in this case, for example, e-mail address 350, program code or billing address 358 to log the purchase. These records may be used later to verify that the shopper has not exceeded his/her limitation restrictions. If physical media has been selected, the order is sent to fulfillment 116. The purchaser may either download the product immediately or delay a specified number of days. An e-mail 118 is sent 374 to the student with a key and a link to download the product. The purchaser uses the link 376 to access and activate the software. The software may be activated either by injecting the key into the product when it is downloaded, or by allowing the student to manually enter the key.

Restrictions on product offers, quantities and eligibility requirements can be set to the vendor's specifications. Restrictions may be created per offer; the shopper may re-enter the store with the unique link and choose from additional product offers on the site, even though they are prevented from purchasing over the limit on the original offer that brought them to the site.

In a preferred embodiment, business rules apply restrictions that will allow shoppers who did not complete an order to eventually complete that order. An order where fraud was attempted will not count toward the item quantity limitation. An order where the credit card did not authorize will not count. An order where the order is completed will count, and an order which was successfully completed and then returned or refunded will count. Changes may be made at the site level; for a vendor with multiple stores in multiple locations, a store for one location may have additional, or fewer, products on sale, and another store may have a completely different list of products.

### Bulk Pre-Purchase Process

An organization, such as a corporate entity, may wish to offer digital products or software as a benefit to its employees and desire to purchase licenses in bulk. For instance, the company using a particular software product may wish to offer employees an identical version of the software program for home use. The company may pre-purchase a number of software activation keys and then provide a link to a storefront allowing employees to log in and purchase discounted copies. An additional embodiment of the e-commerce purchase eligibility determination system provides such functionality.

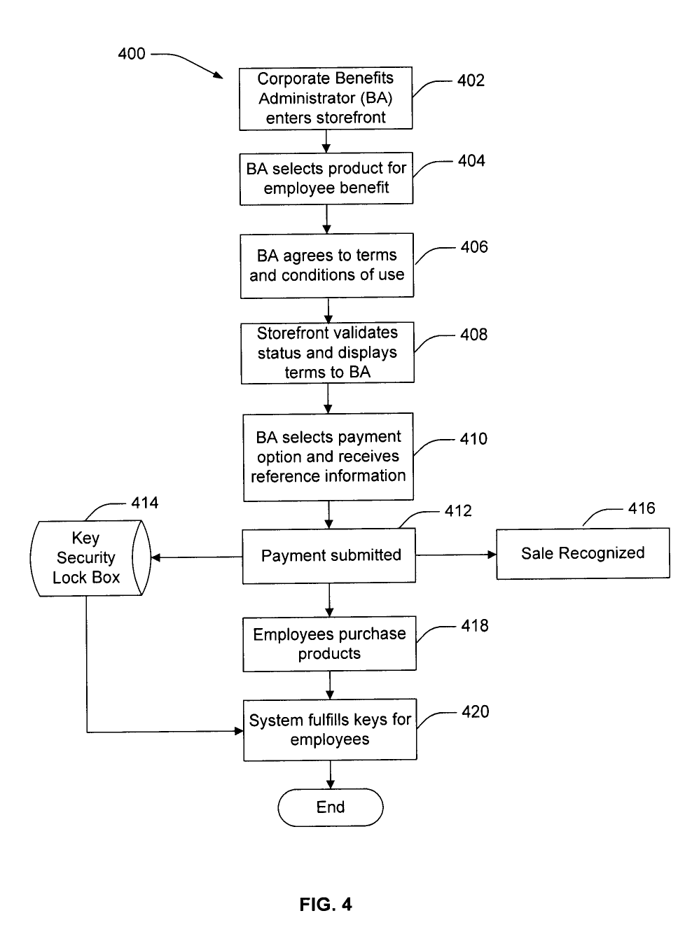

Referring to the pre-process flow illustrated in FIG. 4, a corporate benefits administrator enters the storefront 402 and selects a product for employee benefit 404. The administrator agrees to the terms and conditions of use 406. This agreement may be validated and confirmed 408 before purchase. The administrator selects a payment option and receives reference information 410. Once payment is submitted 412 and the sale recognized 414, software activation keys may be provided to a security lock box 416. As employees purchase the products from the storefront 418 in a process similar to that described above for individual purchasers where the employees utilize one or more white-listed identifiers (e.g., a username, employee number, social security number, etc.) to access the e-commerce system 103, keys may be dispensed from the lock box 416 by the e-commerce system 103 in fulfillment of the order 420.

### Design Solution Methods

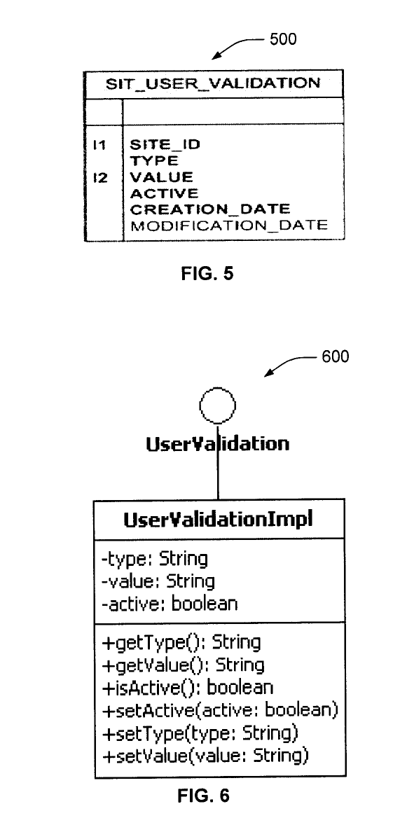

Validation Methods. As described above, an e-commerce purchase eligibility determination system and method may implement a number of business rules related to the sale of deeply discounted items. FIG. 5 shows an exemplary data model 500 for a database table to hold valid qualifying white-list identifiers, such as email addresses, domains, and promotion codes. Table 1 describes the meaning of each value to this example.

TABLE 1
SIT_USER_VALIDATION Data Fields

| Field | Description |
|---|---|
| Site_ID | e-commerce system site identifier |
| Type | Type of qualification (i.e., e-mail address, |
| | domain/sub-domain, promotion code, etc) |
| Value | Value against which requests will be validated |
| Active | Active (yes or no) |
| Creation_date | Date Created |
| Modification_date | Date Modified |

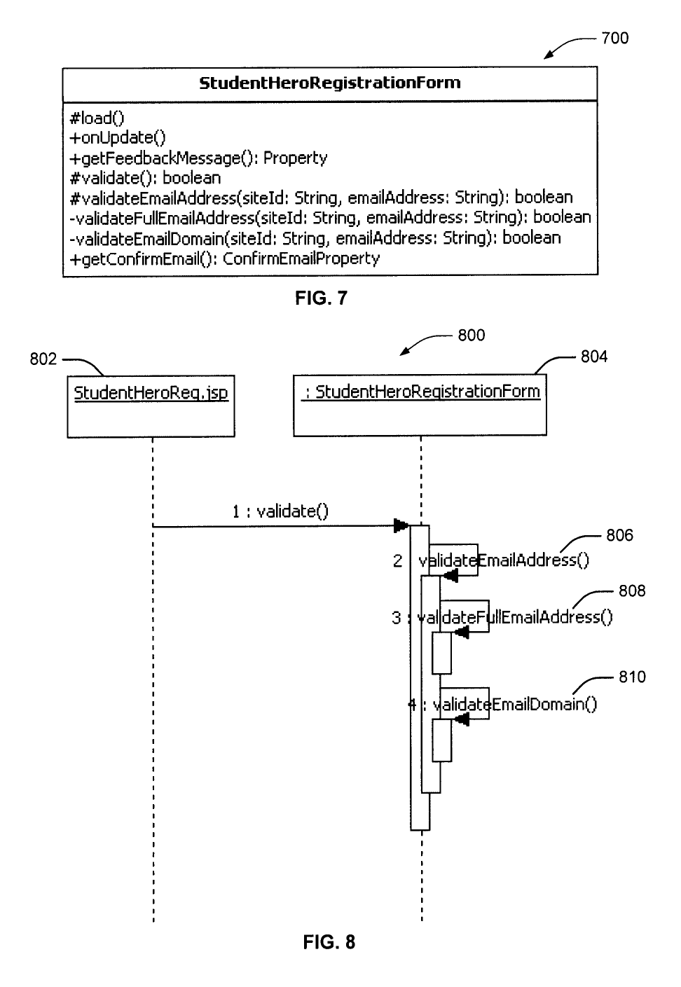

In the examples provided, initial user validation takes place at the time the user registers on the web site. FIG. 6 is an example of a persistence capable domain object for valid identifying values (UserValidationImpl object 600). FIGS. 7 and 8 illustrate the validation process where e-mail is used as the identifying value on the registration form 700. An E-mail address is used in this example, however, the identifying value could also be any other type of identifier, such as a promotional code or program code. When the user enters the identifying value on the registration form 804, the registration form .jsp 802 validates the value through each of its forms. In the example provided, an e-mail address is being used as the identifying value; the identifier may have been described at the e-mail address level 806, the full e-mail address level 808, or the e-mail domain level 810.

For products that have been configured with quantity restrictions, additional validation 362 retrieves product history to determine if the item has previously been sold to the user

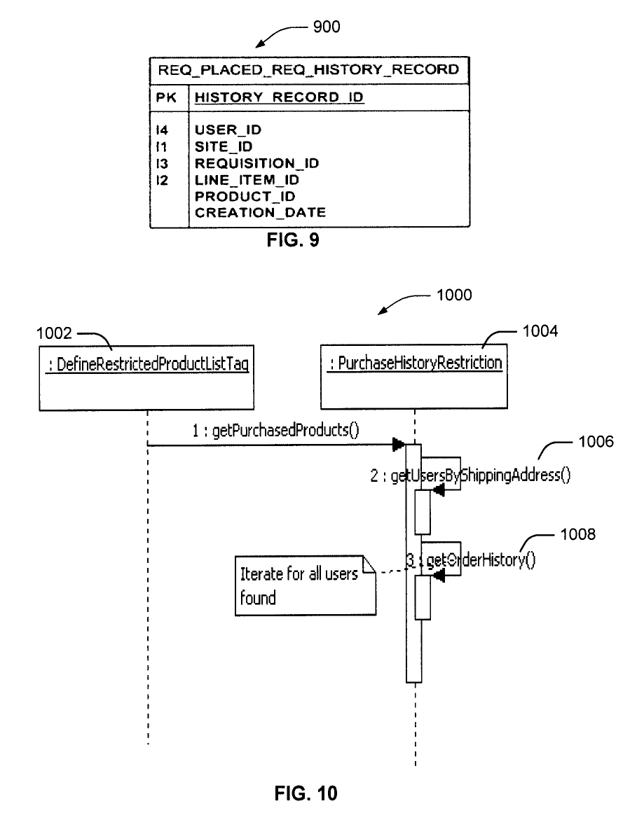

FIG. 9 depicts a data model 900 for product history. Table 2 describes the meaning of each value to this example.

TABLE 2
REQ_PLACED_REQ_HISTORY_RECORD

| Field | Description |
|---|---|
| History_record_id | Record identifier |
| User_id | User's id |
| Site_id | e-commerce system site identifier |
| Requisition_id | Order number |
| Line_item_id | Order Line item number |
| Product_id | Product id |
| Creation_date | Date created |

FIG. 10 is a sequence diagram illustrating the validation that might be used when an item is added to the cart that has been tagged as a restricted product 1002. In this case, the purchase history restriction 1004 applies and the system may check the current address against the shipping addresses for each user 1006, and check the order history for each user found 1008. In this way the system ensures that the quantity restrictions are met.

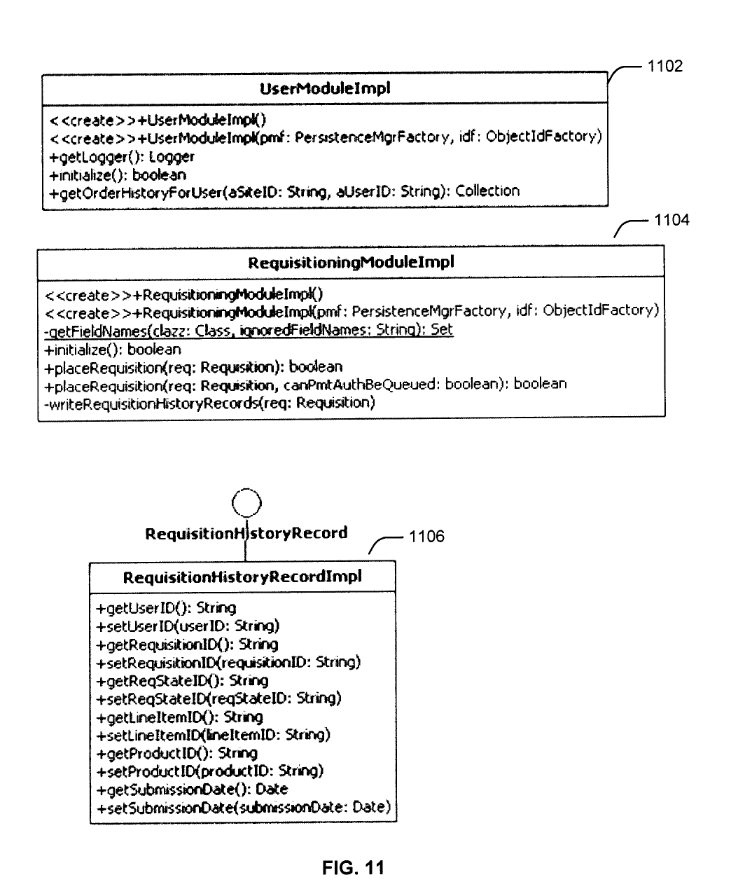

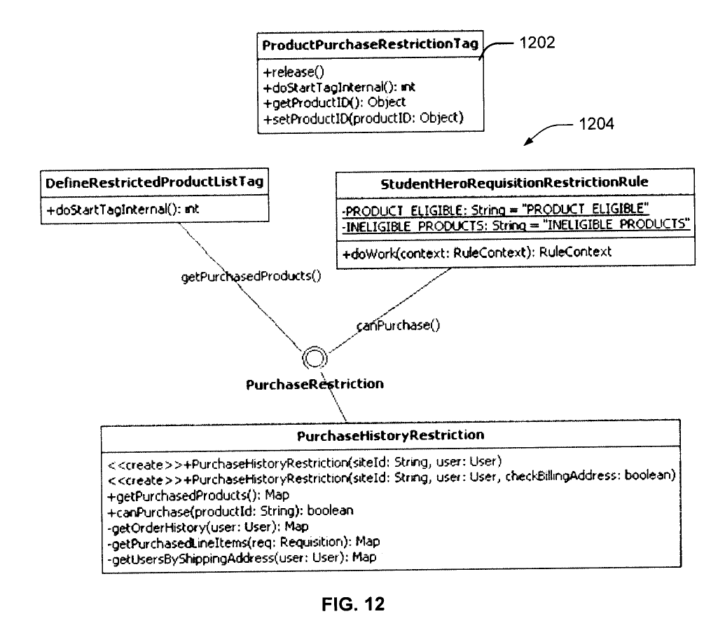

FIGS. 11 and 12 further illustrates the data models for the user 1102, requisitioning 1104 and requisition history modules 1106 and the product purchase restriction tag 1202 used for enforcing purchase restrictions 1204. Pulling product history to ensure that the user has not purchased more than the allotted quantity of any product serves to make the system reliable, accurate and highly performant. The collection of order history may be controlled via a site configuration attribute, which may either be exposed to the administrator GUI, or may be controlled via SQL. In a preferred embodiment where there is more than one store site, an attribute flag for collecting order history may be turned on for all store sites to ensure consistency. Product IDs and line items for submitted requisitions which pass through fraud and payment authorization and have the site configuration attribute setting may be written to a “placed requisition” history record as part of a RequisitioningModule.placeRequisition( )process. A software module containing instructions or code to write to this table may be executed along with code which increments the user's successfully placed orders. The software method associated with the UserModule process can return RequsitionHistoryRecords for the siteID/userID.

After a user logs into the system by way of an end user machine, a process to display the home page looks for a site attribute value to determine the next action or page. If the user has purchased a product, the “buy now” options for that product are disabled or hidden. A custom jsp tag may be created to load or display the page content with a list of previously purchased products associated with that login to a user. A second custom tag may be wrapped around the button on the jsp., and may be used to inspect the purchase history found in the page context looking for a productID. If found, the item is skipped, else it is included on the page. Products not previously purchased should only be added to the shopping cart once. Products may be setup with a maximum quantity value of 1 and checked by an “add item” process.

A back-end purchase history validation process may be performed for each product added to a requisition. An ActionRule for the store site flow to perform the validation may be created utilizing a PurchaseHistoryRestriction object. In addition, back end purchase history validation processes may be performed on the shopping cart contents before submitting the requisition. An ActionRule for the site flow to perform this validation may be created utilizing the PurchaseHistoryRestriction object, as described in FIG. 12.

FIGS. 11 and 12 depict exemplary software classes that allow the system to determine purchase eligibility. Listed in Table 3 below, are some of the additional methods that may be used to implement this process.

TABLE 3
Additional Methods

| Method | Purpose |
|---|---|
| UserModuleImpl | Method to return a user's order history |
| RequisitioningModuleImpl - | Write history records. Called from |
| writeRequisitionHistoryRecords( ) | placeRequistion( ) in addition to incrementing |
| | the successfully placed orders for a user |
| RequisitionHistoryRecord | Persistence capable domain object to handle |
| | the order history records. |
| PurchaseHistoryRestriction | Encapsulates the logic of querying for users |
| | of similar billing address and retrieving order |
| | history for those users. FIG. 10 illustrates |
| | how this method works in conjunction with the |
| | DefineRestrictedProductTag to retrieve the |
| | order history for a particular billing address |
| | and provide that information to pageContext |
| | in order to control the products displayed. |
| StudentHeroRequisitionRestrictionRule | Perform back end validation of contents of |
| | shopping cart against order history utilizing |
| | PurchaseHistoryRestriction. |
| DefineRestrictedProductListTag | Retrieves order history for user utilizing the |
| | PurchaseHistoryRestriction and puts results in |
| | pageContext. |
| ProductPurchaseRestrictionTag | Wraps the buy-now button and inspects the |
| | order history results to determine whether or |
| | not to show/hide the button. |

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the Web interface such that different dialog boxes are presented to a customer that are organized or designed differently while maintaining substantially the same functionality without departing from the scope and spirit of the contemplated invention.

What is claimed is:

1. A method for determining eligibility to purchase performed by an e-commerce system having a server and an end user machine interacting through a network connection during an e-commerce transaction, the method comprising steps of:
receiving a product request and personal identifying information related to the product request at the server from the end user machine;
maintaining a database at the server containing white-listed identifiers, past product purchase information, and eligibility business rules;
determining purchase eligibility at the server by: (a) searching the white-listed identifiers for a match with the received personal identifying information, and (b) verifying a product purchase limit eligibility business rule based on the past product purchase information and the product request; and
allowing at the server only product requests determined to be eligible to proceed to a checkout in the an e-commerce system.

2. The method of claim 1 wherein the receiving step comprises receiving as the personal identifying information at least one of: an e-mail address, promotion code, program code, employee identifier, and organization identifier.

3. The method of claim 2 wherein the determining step comprising searching the white-listed identifiers for a partial match with the received personal identifying information.

4. The method of claim 1 wherein the server performing the method steps is also operatively configured to perform other e-commerce system functions including the checkout.

5. The method of claim 1 further comprising a step of detecting potential fraud associated with the product request at the server.

6. The method of claim 1 further comprising a step of selecting a product from a group of products available to purchase at the end user machine.

7. The method of claim 6 wherein the group of products available for purchase in the selecting step comprises products available based on the eligibility business rules, past product purchase information, and the received personal identifying information.

8. The method of claim 1 further comprising user account validation steps of:
constructing a universal resource locator (URL) link from a user account creation process where the URL link comprises login credentials; and
e-mailing the URL link to an e-mail address associated with a user account.

9. The method of claim 1 further comprising a step of downloading purchased product from the server to the end user machine.

10. The method of claim 9 wherein the downloading step includes injecting a license key into the purchased electronically stored product.

11. The method of claim 1 further comprising a step of e-mailing, after checkout is complete in the e-commerce system, an order notification with download instructions and license key to an e-mail address associated with a user account in the e-commerce system.

12. The method of claim 1 wherein:
the maintaining step comprises a database having a plurality of license keys associated with a bulk product order and eligibility business rule associated with the bulk product order; and
the determining step comprises verifying a product purchase limit eligibility business rule associated with the bulk purchase order based on the past product purchase information associated with the plurality of license keys and the product request.

13. In an e-commerce system having a server and an end user machine interacting through a network connection during an e-commerce transaction, a purchase eligibility determination system comprising:
a database containing white-listed identifiers, past product purchase information, and eligibility business rules;
purchase eligibility determination module operatively configured to cause the server to determine purchase eligibility by: (a) searching the white-listed identifiers in the database for a match with personal identifying information received through the network from the end user machine, (b) verifying a product purchase limit eligibility business rule from the database based on the past product purchase information and a product request received through the network from the end user machine, and (c) allowing an e-commerce transaction to proceed to a checkout in the an e-commerce system only when the match of a white-listed identifier is found in the database and the product purchase limit eligibility business rule is verified.

14. The purchase eligibility determination system of claim 13 wherein the personal identifying information received by the purchase eligibility determination module comprises at least one of: an e-mail address, promotion code, program code, employee identifier, and organization identifier.

15. The purchase eligibility determination system of claim 14 wherein the purchase eligibility determination module is operatively configured to search the white-listed identifiers for a partial match with the received personal identifying information.

16. The purchase eligibility determination system of claim 13 further comprising a fraud detection module operatively configured to cause the server to detect fraud potential fraud associated with the product request and allowing an e-commerce transaction to proceed to the checkout in the an e-commerce system only when the potential fraud is not detected.

17. The purchase eligibility determination system of claim 13 further comprising a user account validation module operatively configured to cause the server to: (a) construct a universal resource locator (URL) link from a user account creation process where the URL link comprises login credentials, and (b) e-mail the URL link to an e-mail address associated with a user account.

18. The purchase eligibility determination system of claim 17 further comprising a customized user page module operatively configured to cause the server to: (a) automatically login a user into the e-commerce system when the URL link is selected at the end user machine and (b) causing display of a group of products available for purchase at the end user machine, the group of products being based on the eligibility business rules, past product purchase information, and the received personal identifying information.

19. The purchase eligibility determination system of claim 13 wherein the purchase eligibility determination module is operatively configured to verify a product purchase limit eligibility business rule based on at least one of a billing address for the e-commerce transaction, past product purchase information, and a portion of the received personal identifying information.

20. The purchase eligibility determination system of claim 13 wherein the database further comprises a plurality of license keys associated with a bulk product order and eligibility business rule associated with the bulk product order, and the verifying in the purchase eligibility determination module comprises verifying a product purchase limit eligibility business rule associated with the bulk purchase order based on the past product purchase information associated with the plurality of license keys and the product request.
